(19) United States
(12) Patent Application Publication
(10) Pub. No.: US 2017/0205739 A1
(43) Pub. Date: Jul. 20, 2017

(54) FIXING DEVICE AND IMAGE FORMING APPARATUS

(71) Applicant: KYOCERA Document Solutions Inc., Osaka (JP)

(72) Inventors: Shinji YAMANE, Osaka-shi (JP); Ryohei TOKUNAGA, Osaka-shi (JP)

(73) Assignee: KYOCERA Document Solutions Inc., Osaka (JP)

(21) Appl. No.: 15/367,571

(22) Filed: Dec. 2, 2016

(30) Foreign Application Priority Data
Jan. 15, 2016 (JP) 2016-006169

(51) Int. Cl. G03G 15/20

(52) U.S. Cl. CPC G03G 15/2028

(57) ABSTRACT

A fixing device includes a fixing member, a pressuring member, a separation member and a bearing. The fixing member is heated by a heat source. The pressuring member is brought into pressure contact with the fixing member to form a fixing nip with the fixing member. The separation member has a main body part and a shaft part projecting in an axial direction from the main body part to become the rotation center, and is configured so that one end of the main body part come into contact with the fixing member. The bearing pivotally supports the shaft part of the separation member. The bearing is formed so that its contact portion coming into contact with the shaft part has shorter width in the axial direction than other portion.

### INCORPORATION BY REFERENCE

This application is based on and claims the benefit of priority from Japanese Patent application No. 2016-006169 filed on Jan. 15, 2016, the entire contents of which are incorporated herein by reference.

### BACKGROUND

The present disclosure relates to a fixing device fixing a toner image onto a sheet and an image forming apparatus including this fixing device.

Conventionally, in an image forming apparatus, an image carrier, such as a photosensitive drum, is electrically charged and exposed on the basis of image data, thereby forming an electrostatic latent image on the image carrier, and then, this electrostatic latent image is developed by a development device to form a toner image. Subsequently, this toner image is transferred onto a sheet, and further, the toner image on the sheet is heated and pressured by a fixing device, thereby fixing the toner image onto the sheet.

As the fixing device, there are a roller-fixing type device forming a fixing nip between a heating roller and a pressuring roller and a sliding belt type device forming a fixing nip between a fixing belt and a pressuring roller. The fixing device uses a separation member, such as a separation claw or a separation plate, or applies self-stripping to separate and to convey the sheet outputted from the fixing nip.

For example, a fixing device including a separation claw and a sub-housing is known. The separation claw is connected to a spring and includes a projection portion and a rotation shaft having both ends formed in a roughly oval shape or an ellipse shape. The sub-housing includes an oblique motion rib and a slit-like bearing having a slit formed in a relationship of C<A<D<B, in which A is an upper slit width, B is a lower slit width, C is a shortest diameter of both ends of the separation claw and D is a longest diameter of both ends of the separation claw. Then, in order to hold the separation claw at a predetermined position, in a state that both ends are positioned at the lower slit and the projection portion comes into contact with the oblique motion rib, the separation claw is turned in a reverse biasing direction of the spring.

The fixing device may apply a low temperature fixable toner for environment responsibility, such as energy saving and device downsizing, and the low temperature fixable toner contains a low melting wax component for improving a fixing performance and others. The wax component may volatilize and adhere to a separation member bearing as the above-mentioned slit-like bearing. In such a case, when temperature of the fixing device is lowered to nearly room temperature, the wax component is solidified at the separation member bearing. After that, when the fixing device is activated, operation failure of the separation member may occur and a paper jam may occur.

### SUMMARY

In accordance with an embodiment of the present disclosure, a fixing device includes a fixing member, a pressuring member, a separation member and a bearing. The fixing member is heated by a heat source. The pressuring member is brought into pressure contact with the fixing member to form a fixing nip with the fixing member. The separation member has a main body part and a shaft part projecting in an axial direction from the main body part to become the rotation center, and is configured so that one end of the main body part come into contact with the fixing member. The bearing pivotally supports the shaft part of the separation member. The bearing is formed so that its contact portion coming into contact with the shaft part has shorter width in the axial direction than other portion.

In accordance with an embodiment of the present disclosure, an image forming apparatus includes the above-mentioned fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a sectional view showing a printer according to an embodiment of the present disclosure.

FIG. 2 is a sectional view showing a fixing device of the printer according to the embodiment of the present disclosure.

FIG. 3 is a perspective view showing bearings for separation members in the fixing device of the printer according to the embodiment of the present disclosure.

FIG. 4 is an enlarged perspective view showing the bearing for the separation member in the fixing device of the printer according to the embodiment of the present disclosure.

FIG. 5 is a perspective view showing the separation member and the bearing in the fixing device of the printer according to the embodiment of the present disclosure.

FIG. 6 is an enlarged side view showing one example of the bearing in the fixing device of the printer according to the embodiment of the present disclosure.

FIG. 7 is an enlarged side view showing another example of the bearing in the fixing device of the printer according to the embodiment of the present disclosure.

FIG. 8 is an enlarged side view showing a still another example of the bearing in the fixing device of the printer according to the embodiment of the present disclosure.

FIG. 9 is an enlarged side view showing a further example of the bearing in the fixing device of the printer according to the embodiment of the present disclosure.

### DETAILED DESCRIPTION

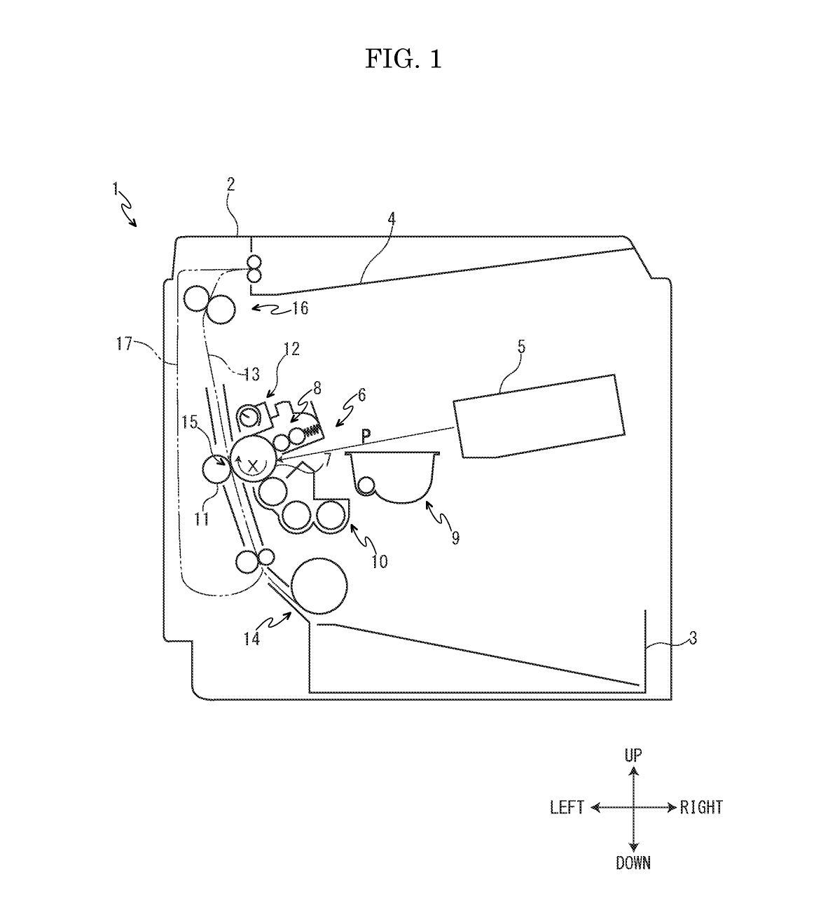

First, with reference to FIG. 1, the entire structure of a printer 1 (an image forming apparatus) will be described. Hereinafter, for convenience of explanation, it will be described so that the front side of the printer 1 is positioned at a near side of a paper sheet of FIG. 1.

The printer 1 includes a box-like formed printer main body 2. At a lower side inside the printer main body 2, a sheet feeding cartridge 3 storing sheets (not shown) is installed. In an upper end of the printer main body 2, an ejected sheet tray 4 is formed.

At a right side inside the printer main body 2, an exposure device 5 composed of a laser scanning unit (LSU) is located. At a left side inside the printer main body 2, an image forming part 6 is arranged. In the image forming part 6, a photosensitive drum 7 as an image carrier is rotatably arranged. Around the photosensitive drum 7, a charging device 8, a development device 10 connected to a toner container 9, a transfer roller 11 and a cleaning device 12 are located along a rotating direction (refer to an arrow X in FIG. 1) of the photosensitive drum 7. For example, in the toner container 9, a toner containing a low melting wax component is stored. The development device 10 is configured to carry out developing process using the toner containing the low melting wax component.

Incidentally, as the low melting wax component applied in a low temperature fixable toner used in the present disclosure, there are a paraffin wax, an olefin wax, a polyolefin wax, a microcrystalline wax, a Fischer-Tropsch wax, a polyethylene wax, a polypropylene wax and derivative from any one of them. Above all, a normal chain aliphatic hydrocarbon wax composed of a normal chain aliphatic hydrocarbon compound is preferable, in which melting point of its wax is 100 degrees or less and a 40-42 C hydrocarbon compound accounting for a maximum abundance ratio in the wax is 6 percent or more.

At the left side inside the printer main body 2, a conveying path 13 for the sheet is arranged from a lower side to an upper side. At an upstream end of the conveying path 13, a sheet feeding part 14 is positioned. At an intermediate stream portion of the conveying path 13, a transferring part 15 composed of the photosensitive drum and the transfer roller 11 is positioned. At a downstream side of the conveying path 13, a fixing device 16 is positioned. At the left side of the conveying path 13, an inversion path 17 for duplex printing is arranged.

Next, image forming operation of the printer 1 including such a configuration will be described.

When the power is supplied to the printer 1, various parameters are initialized and initial determination, such as temperature determination of the fixing device 16, is carried out. Subsequently, in the printer 1, when image data is inputted and a printing start is directed from a computer or the like connected with the printer 1, image forming operation is carried out as follows.

First, the surface of the photosensitive drum 7 is electrically charged by the charging device 8. Then, photographic exposure corresponding to the image data is carried out to the photosensitive drum 7 by a laser light (refer to an arrow P in FIG. 1) from the exposure device 5, thereby forming an electrostatic latent image on the surface of the photosensitive drum 7. Next, the electrostatic latent image is developed to a toner image by the development device 10 using with the toner supplied from the toner container 9.

On the other hand, the sheet picked up from the sheet feeding cartridge 3 by the sheet feeding part 14 is conveyed to the transferring part 15 in a suitable timing for the above-mentioned image forming operation. In the transferring part 15, the toner image on the photosensitive drum 7 is transferred onto the sheet. The sheet with the transferred toner image is conveyed to a downstream side in the conveying path 13 to go into the fixing device 16. In the fixing device 16, the toner image is fixed on the sheet. The sheet with the fixed toner image is ejected from a downstream end in the conveying path 13 to the sheet ejected tray 4. Incidentally, the toner remained on the photosensitive drum 7 is collected by the cleaning device 12.

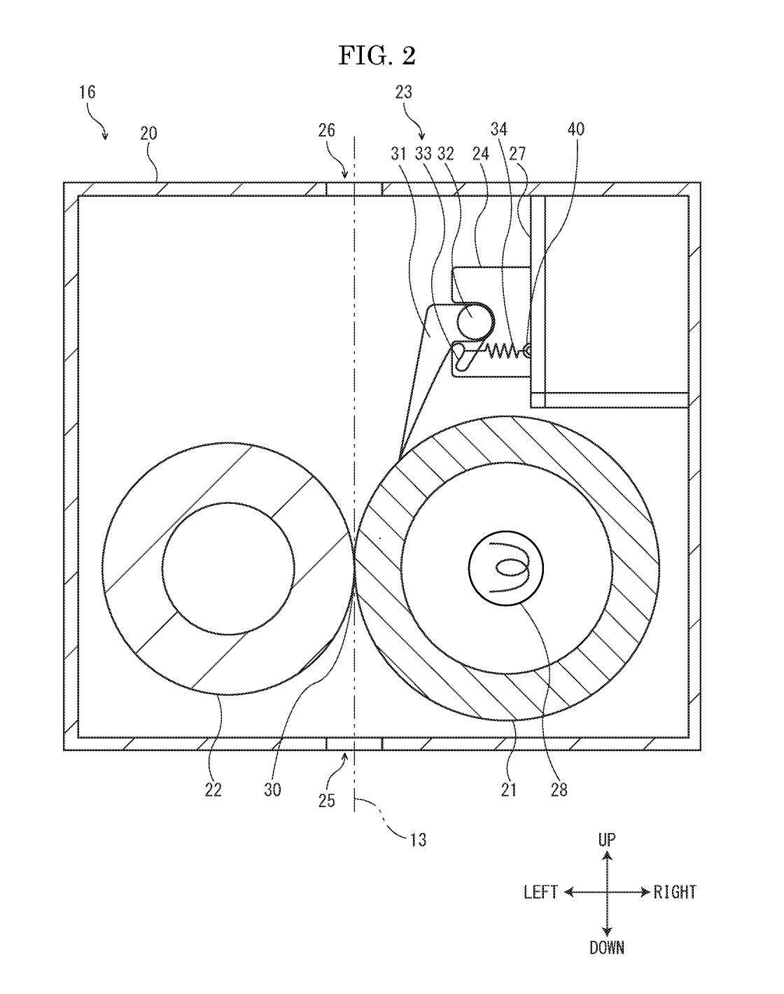

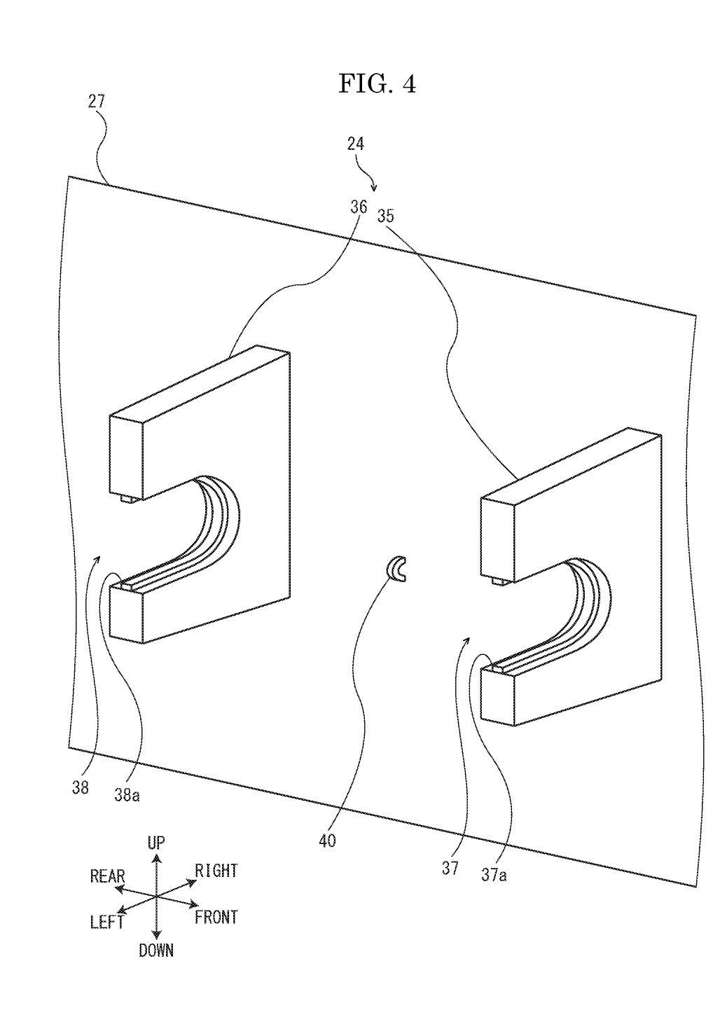

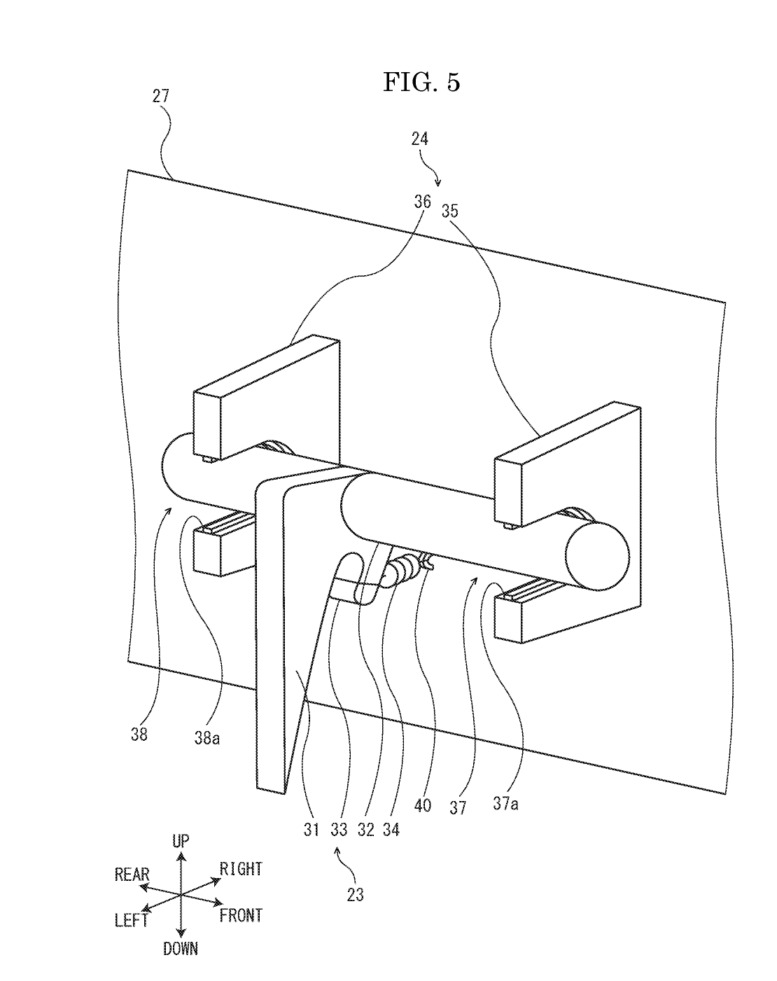

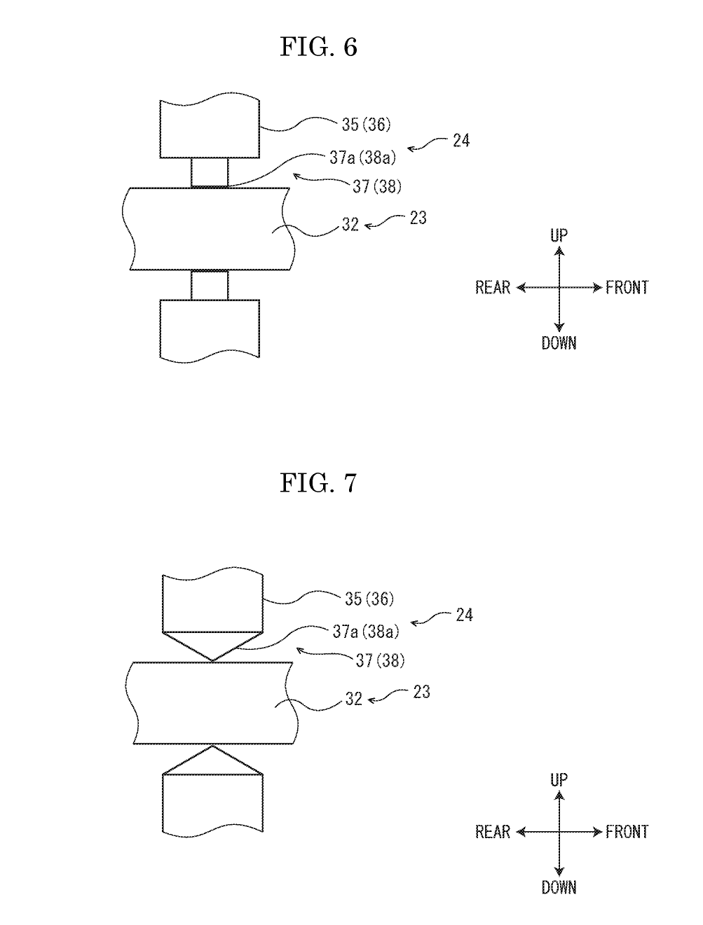

Next, the fixing device 16 will be described with reference to FIG. 2 to FIG. 9.

As shown in FIG. 2, the fixing device 16 includes a housing 20, a fixing roller 21 (a fixing member) installed at a right lower side inside the housing 20, a pressuring roller 22 (a pressuring member) installed at a left lower side inside the housing 20, separation members 23 arranged above the fixing roller 21 and bearings 24 pivotally supporting the separation members 23.

The housing 20 is formed in a box-like shape elongated in forward and backward directions. The housing 20 has a sheet feeding port 25 opened at a roughly center in left and right directions of its lower face and a sheet ejecting port 26 opened at a roughly center in the left and right directions of its upper face. The fixing device 16 is configured so that the sheet fed into the housing 20 via the sheet feeding port 25 is ejected from the housing 20 via the sheet ejecting port 26. At a right upper side inside the housing 20, a plate-like upper frame 27 elongated in the forward and backward directions is provided. The upper frame 27 may be formed integrally with the housing 20 or may be a separate component attached to the housing 20.

The fixing roller 21 is formed in a columnar shape elongated in the forward and backward directions. The fixing roller 21 has a rotation shaft elongated in the forward and backward directions and is rotatably supported inside the housing 20. The fixing roller 21 is composed of a cylindrical core material made of metal, such as aluminum or iron, an elastic layer made of silicon rubber or the like and provided around the core material and a release layer made of fluorine-based resin, such as PFA (Perfluoro alkoxy alkane) or the like, and covering the elastic layer.

Inside the fixing roller, a heater 28 (a heat source) is provided. The heater 28 is composed of, for example, a halogen heater, a ceramic heater or the like. The heater 28 is configured to generate heat by electrifying and to heat the fixing roller 21.

The pressuring roller 22 is formed in a columnar shape elongated in the forward and backward directions. The pressuring roller 22 has a rotation shaft 22a elongated in the forward and backward directions and is rotatably supported inside the housing 20. The pressuring roller 22 is composed of a cylindrical core material made of metal, such as aluminum or iron, an elastic layer made of silicon rubber or the like and provided around the core material and a release layer made of fluorine-based resin, such as PFA (Perfluoro alkoxy alkane) or the like, and covering the elastic layer. The pressuring roller 22 is brought into pressure contact with the fixing roller 21 by biasing force of a biasing member (not shown) to form a fixing nip 30 with the fixing roller 21.

Each of the separation members 23 has a main body part 31 and a shaft part 32. The main body part 31 of the separation member 23 has a predetermined thickness in the forward and backward directions and has a shape tapered from an upper side to a lower side, i.e. is structured as a separation claw. At a right end of the main body part 31, a hook 33 is formed and, to the hook 33, one end of a biasing member 34, such as a tension spring or a torsion coil spring, biasing the separation member 23 to a right side is attached. For example, as shown in FIG. 2, in a case where the biasing member 34 is composed of the tension spring, another end of the biasing member 34 is fastened to a spring fastening part 40 formed in the upper frame 27. Alternatively, in a case where the biasing member 34 is composed of the torsion coil spring, another end of the biasing member 34 is fastened to the shaft part 32.

The shaft part 32 of the separation member 23 is configured to project to both sides in the forward and backward directions (an axial direction of the fixing roller 21) from an upper portion of the main body part 31, thereby becoming a rotation center of the separation member 23. Then, the separation member 23 is arranged to rotate via the shaft part 32 and makes a lower end (one end) of the main body part 31 come into contact (approach) with the fixing roller 21 by biasing force (e.g. a load of approximately 3-10 grams) of the biasing member 34. Thereby, it is possible to separate the sheet from an outer circumference face of the fixing roller 21 by the separation member 23.

A plurality of the bearings 24 are arranged at intervals in the forward and backward directions and are formed integrally with the upper frame 27 at the right upper side inside the housing 20. Each bearing 24 is composed of a pair of a bearing front part 35 and a bearing rear part 36. The bearing front part 35 and the bearing rear part 36 are similar plate-like shapes having predetermined thicknesses in the forward and backward directions, arranged at an interval in the forward and backward directions and projected from the upper frame 27 to a left side.

In left ends of the bearing front part 35 and the bearing rear part 36, bearing recessed portions 37 and 38 are recessed at roughly centers in upward and downward directions. The bearing recessed portions 37 and 38 are configured to pivotally support the shaft part 32 of the separation member 23. On respective inner faces of the bearing recessed portions 37 and 38, contact portions 37a and 38a coming into contact with an outer circumference face of the shaft part 32 are provided and the contact portions 37a and 38a are formed in a thin ridged shape. These contact portions 37a and 38a have thinner thicknesses (shorter widths) in the forward and backward directions (the axial direction of the fixing roller 21) than other portions of the bearing front part 35 and the bearing rear part 36. The thicknesses of the contact portions 37a and 38a are set, for example, within a range approximately from one three to one ten with respect to thicknesses of other portions of the bearing front part 35 and the bearing rear part 36.

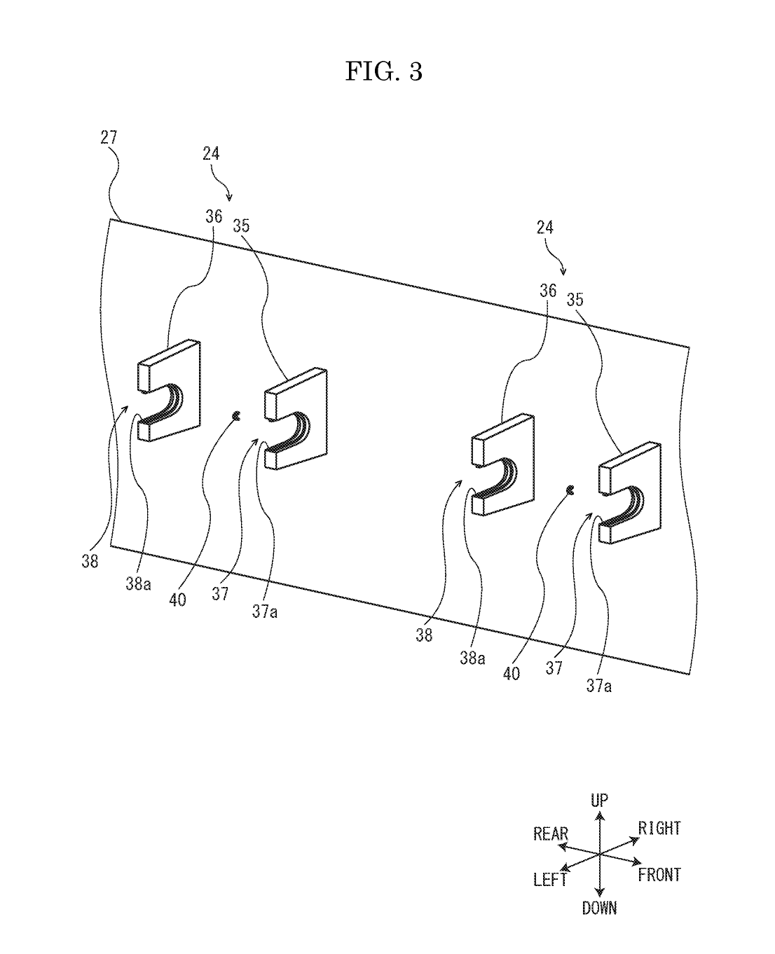

For example, as shown in FIG. 3 to FIG. 6, the respective contact portions 37a and 38a of the contact portions 37a and 38a are formed in step-like shapes with respect to other portions of the bearing front part 35 and the bearing rear part 36. These contact portions 37a and 38a have symmetrical shapes with respect to respective centers in the forward and backward directions.

In accordance with the embodiment, as described above, the fixing device 16 of the printer 1 (the image forming apparatus) includes the fixing roller 21 (the fixing member), the pressuring roller 22 (the pressuring member), the separation member 23 and the bearing 24. The fixing roller 21 is heated by the heater 28 (the heat source). The pressuring roller 22 is brought into pressure contact with the fixing roller 21 to form the fixing nip 30 with the fixing roller 21. The separation member 23 has the main body part 31 and the shaft part 32 projecting in the forward and backward directions (the axial direction of the fixing roller 21) from the main body part 31 to become the rotation center and is configured so that the lower end (one end) of the main body part 31 come into contact with the fixing roller 21. The bearing 24 pivotally supports the shaft part 32 of the separation member 23. Further, the bearing 24 is formed so that the respective contact portions 37a and 38a of the bearing recessed portions 37 and 38 coming into contact with the shaft part 32 have thinner thicknesses (shorter widths) in the forward and backward directions than other portions.

According to such a configuration, since a contact area between the separation member 23 and the bearing 24 is narrowed (reduced), it is possible to decrease starting torque of the separation member 23. Accordingly, in a case where the toner containing the low melting wax component is used, if the volatilized wax component is adhered to the bearing 24, it is possible to maintain excellent motion of the separation member 23. Thus, it is possible to reduce an effect of dirt due to the wax component of the toner in the bearing 24 for the separation member 23. Therefore, it is possible to prevent operation failure of the separation member 23, to prevent a paper jam due to operation failure of the separation member 23 and to actualize stable conveying performance.

In addition, in accordance with the embodiment, the contact portions 37a and 38a of the bearing 24 are formed in step-like shapes with respect to other portions.

Thereby, it is possible to narrow (reduce) the contact area between the separation member 23 and the bearing 24 by a simple configuration.

Although, in the above-described embodiment, a configuration forming the contact portions 37a and 38a of the bearing recessed portions 37 and 38 of the bearing 24 in step-like shapes is described, the configuration of the contact portions 37a and 38a is not restricted by this. For example, in another embodiment, as shown in FIG. 7, the respective contact portions 37a and 38a of the bearing recessed portions 37 and 38 may be inclined so as to gradually separate from the shaft part 32 of the separation member 23 as they go from respective center sides to outsides in the forward and backward directions. In other words, the contact portions 37a and 38a shown in FIG. 7 are formed in tapered shapes toward the respective center sides in the forward and backward directions.

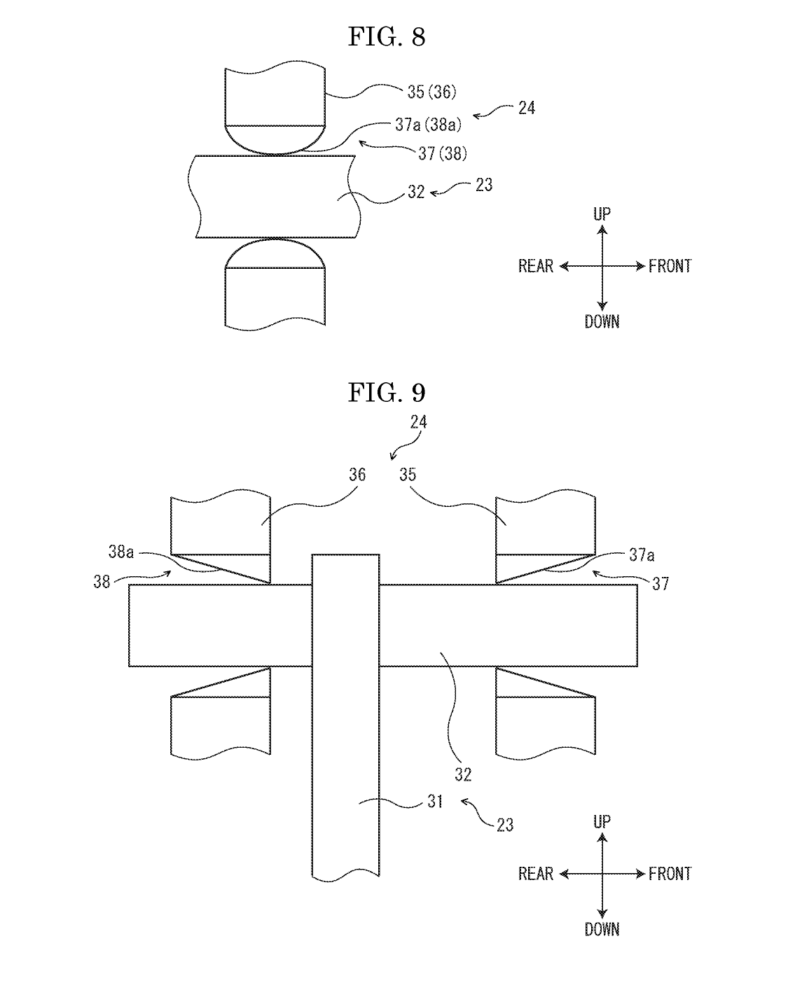

Alternatively, in still another embodiment, as shown in FIG. 8, the respective contact portions 37a and 38a of the bearing recessed portions 37 and 38 may be curved so as to gradually separate from the shaft part 32 of the separation member 23 as they go from respective center sides to outsides in the forward and backward directions.

In even these other embodiments, it is possible to narrow (reduce) the contact area between the separation member 23 and the bearing 24 by simple configurations. Moreover, since the contact portions 37a and 38a are inclined or curved toward the outsides in the forward and backward directions, it is possible to flow the toner and its wax component scattered to the bearing 24 out to the outsides of the contact portions 37a and 38a.

Although, in the above-described embodiment, a configuration forming the bearing recessed portions 37 and of the bearing 24 in similar plate-like shapes and forming the respective contact portions 37a and 38a of the bearing recessed portions 37 and 38 in symmetrical shapes with respect to respective centers in the forward and backward directions is described, the configuration of the contact portions 37a and 38a is not restricted by this. For example, in further embodiment, the contact portions 37a and 38a may be formed in asymmetrical shapes in the forward and backward directions. The respective contact portions 37a and 38a of these bearing recessed portions 37 and 38 may be, for example, as shown in FIG. 7, inclined so as to gradually separate from the shaft part 32 as they go from nearer sides from further sides with respect to the main body part 31 of the separation member 23 in the forward and backward directions.

In even this further embodiment, it is possible to narrow (reduce) the contact area between the separation member 23 and the bearing 24 by a simple configuration. Moreover, since the contact portions 37a and 38a are inclined toward the outsides in the forward and backward directions, it is possible to flow the toner and its wax component scattered to the bearing 24 out to the outsides of the contact portions 37a and 38a.

Although, in the above-described embodiment, a configuration of the separation member 23 having the main body part as the separation claw is described, the separation member 23 is not restricted by this. For example, in furthermore embodiment, the separation member 23 may have a substitute main body part 31 as a separation plate with a predetermined length in the forward and backward directions.

Although, in the above-described embodiment, a configuration of the fixing device 16 including the fixing member as the fixing roller 21 is described, the fixing member is not restricted by this. The fixing member may be configured to include a fixing belt.

Although, in the above-described embodiment, a configuration applying the heater 28 as the heat source is described, in another different embodiment, for example, another heat source, such as an IH (Induction Heating) coil, may be applied.

The embodiment was described in a case of applying the configuration of the present disclosure to the printer 1. On the other hand, in another embodiment, the configuration of the disclosure may be applied to another image forming apparatus, such as a copying machine, a facsimile or a multifunction peripheral.

Further, the above-description of the embodiments was described about one example of the image forming apparatus including this according to the present disclosure. However, the technical scope of the present disclosure is not limited to the embodiments. Components in the embodiment described above can be appropriately exchanged with existing components, and various variations including combinations with other existing components are possible. The description of the embodiment described above does not limit the content of the disclosure described in the claims.

What is claimed is:

1. A fixing device comprising:
a fixing member heated by a heat source;
a pressuring member brought into pressure contact with the fixing member to form a fixing nip with the fixing member;
a separation member having a main body part and a shaft part projecting in an axial direction from the main body part to become the rotation center, and configured so that one end of the main body part come into contact with the fixing member; and
a bearing pivotally supporting the shaft part of the separation member,
wherein the bearing is formed so that its contact portion coming into contact with the shaft part has shorter width in the axial direction than other portion.

2. The fixing device according to claim 1, wherein
the contact portion of the bearing is formed in a step-like shape with respect to other portion.

3. The fixing device according to claim 1, wherein
the contact portion of the bearing is inclined so as to gradually separate from the shaft part as the contact portion goes to the outside from the center side in the axial direction.

4. The fixing device according to claim 1, wherein
the contact portion of the bearing is curved so as to gradually separate from the shaft part as the contact portion goes to the outside from the center side in the axial direction.

5. The fixing device according to claim 1, wherein
the contact portion of the bearing is inclined so as to gradually separate from the shaft part as the contact portion goes from a nearer side from a further side with respect to the main body part in the axial direction.

6. The fixing device according to claim 1 further comprising:
a biasing member biasing the separation member so that one end of the main body part approaches the fixing member.

7. The fixing device according to claim 1, wherein
the bearing is configured so that thickness of the contact portion is set within a range approximately from one three to one ten with respect to thickness of other portion.

8. The fixing device according to claim 1 fixing a toner image formed by a toner containing a low melting wax component onto a sheet.

9. An image forming apparatus comprising the fixing device according to claim 1.

10. An image forming apparatus comprising the fixing device according to claim 2.

11. An image forming apparatus comprising the fixing device according to claim 3.

12. An image forming apparatus comprising the fixing device according to claim 4.

13. An image forming apparatus comprising the fixing device according to claim 5.

14. An image forming apparatus comprising the fixing device according to claim 6.

15. An image forming apparatus comprising the fixing device according to claim 7.

16. An image forming apparatus comprising the fixing device according to claim 8.
